(19) United States
(12) Patent Application Publication
(10) Pub. No.: US 2025/0094827 A1
(43) Pub. Date: Mar. 20, 2025

(54) Producing a Reduced-Size Model by Explanation Tuning

(71) Applicant: Microsoft Technology Licensing, LLC, Redmond, WA (US)

(72) Inventors: Ahmed AWADALLAH, Redmond, WA (US); Arindam MITRA, Redmond, WA (US); Sahaj Raghvendra AGARWAL, Surat (IN); Hamid PALANGI, Kirkland, WA (US); Subhabrata MUKHERJEE, Kirkland, WA (US)

(73) Assignee: Microsoft Technology Licensing, LLC, Redmond, WA (US)

(21) Appl. No.: 18/510,407

(22) Filed: Nov. 15, 2023

Related U.S. Application Data
(60) Provisional application No. 63/538,548, filed on Sep. 15, 2023.

(51) Int. Cl. G06N 5/02

(52) U.S. Cl. CPC G06N 5/02

(57) ABSTRACT

A technique produces a reduced-size language model using explanation tuning. Explanation tuning composes a prompt that includes two parts: a system instruction and a client instruction. The client instruction expresses a query. The system instruction requests a language model to formulate responses to queries that describe final results and processes of producing the final results. The language model responds to the prompt by providing a language-model response that describes a final result and a process of producing the final result, e.g., by providing a step-by-step explanation of how the final result is derivable. In some implementations, the technique uses a teacher-student approach to producing the reduced-size language model. In some examples, the technique performs training in two stages using two respective teacher language models, the first-stage model being less versatile and accurate compared to the second-stage model.

This application claims the benefit of U.S. Provisional Application No. 63/538,548 (the '548 Application), filed on Sep. 15, 2023. The '548 Application is incorporated by reference herein in its entirety.

### BACKGROUND

Large language models are capable of successfully responding to a broad range of input queries. But some of these language models have a relatively large number of parameters. Not every computing device is capable of storing and implementing such a large language model. For example, a user computing device that has limited memory and processing resources may not be able to feasibly implement a large language model. It is also impractical to download a large language model from a source system.

To overcome this limitation, an application can be configured to interact with a network-accessible language model. This solution, however, is not ideal. First, interaction with a network-accessible model incurs a latency cost. Second, an application developer may wish to eliminate interaction with a network-accessible model for privacy-related reasons. Further, a client-side application does not have uninterrupted access to a network-accessible model at all times. In addition, or alternatively, an application developer may simply wish to avoid incurring the fees associated with interacting with a proprietary online language model.

One approach for producing a reduced-size model is knowledge distillation. This approach uses a typically large and robust teacher language model to iteratively transfer its knowledge to a smaller student language model. Such a smaller-sized student language model, however, can produce output results having low quality.

### SUMMARY

A technique is described herein for producing a reduced-size language model using explanation tuning. Explanation tuning composes a prompt that includes two parts: a system instruction and a client instruction. The client instruction expresses a query. The system instruction requests a language model to formulate responses to queries in a detailed and expansive manner, e.g., by explaining final results and processes for producing the final results. Different system instructions convey this request in different respective ways, some being more explicit than others. The language model responds to the prompt by providing a language-model response that describes a final result and a process of producing the final result, e.g., by specifying how the final result is derivable in a step-by-step manner.

In some implementations, the technique uses a teacher-student approach to producing the reduced-size language model. In this approach, the technique requests a teacher language model to generate a teacher-model response based on the kind of two-part prompt described above. In response, the teacher language model produces a teacher-model response that describes a teacher-model final result and a process of producing the teacher-model final result. The technique requests a student language model to also generate a detailed student-model response in the above-described manner. The technique compares the student-language response with the teacher-model response, and based thereon, updates the parameters of the student language model. When training is finished, the student language model constitutes a client language model for use in inference-stage operations.

In some implementations, the teacher language model is a different language model than the student language model. In some implementations, the teacher language model is specifically a more capable language model than the student language model.

In other implementations, the teacher language model and the student language model are the same language model that operates in a teacher context and a student context, respectively.

In some implementations, the technique performs training in at least two stages. In a first stage, the technique performs training using a first set of training examples that are produced using a first teacher language model. In a second stage, the technique performs training using a second set of training examples that are produced using a second teacher language model. In some implementations, the second teacher language model has greater capability than the first teacher language model.

In some implementations, the client language model (corresponding to the trained student language model) is implemented by a local system which is capable of operating in an offline mode.

The technique is technically advantageous because it provides a reduced-sized client language model that produces high-quality results. Together, these characteristics make a local implementation of the language model a feasible prospect. In particular, by virtue of the use of explanation tuning, the client language model learns how to duplicate the capabilities of a more powerful teacher language model. This capability, in turn, enables the client language model to apply the logic to new kinds of queries, not explicitly encountered in the training examples. Alternative techniques (which do not use explanation tuning) produce inferior results because they only learn to mimic the surface-level patterns between teacher-model responses and student-model responses; they cannot apply the logic associated with the responses to new cases which share the same logic, but have a different surface manifestation.

The operation of a reduced-size client model involves a reduced use of resources (such as processing resources and memory resources), compared to larger client models. It is also feasible to download such a reduced-size client model from a source system, and run it on a local system (e.g., a local computing device). A locally-implemented client language model is capable of operating in an offline mode, without interaction with network-accessible resources.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows how a training system performs a first part of a training operation.

FIG. 2 shows a group of illustrative system instructions, for use by the training system of FIG. 1 in composing prompts.

FIG. 3 shows an example of how a teacher language model in the training system of FIG. 1 transforms a particular prompt into a teacher-model response.

FIG. 4 shows how the training system performs a second part of the training operation.

FIG. 5 shows how a local system implements a client language model produced using the training system of FIGS. 1 and 4.

FIGS. 6 and 7 show two tables that describe the performance of the client language model of FIG. 5, in comparison to other language models.

FIG. 8 shows a key for interpreting information presented in FIGS. 9-12.

FIGS. 9-12 show variations of the systems and processes set forth with respect to FIGS. 1-5.

FIG. 13 shows an illustrative language model for use the systems of FIGS. 1, 4, and 5.

FIG. 14 is a flowchart that provides an overview of one manner of operation of the training system of FIGS. 1 and 4.

FIG. 15 is a flowchart that provides an overview of another aspect of the operation of the training system of FIGS. 1 and 4.

FIG. 16 is a flowchart that provides an overview of one manner of operation of the local system of FIG. 5.

FIG. 17 shows computing equipment that, in some implementations, is used to implement the computing system of FIG. 1.

FIG. 18 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Illustrative Training System

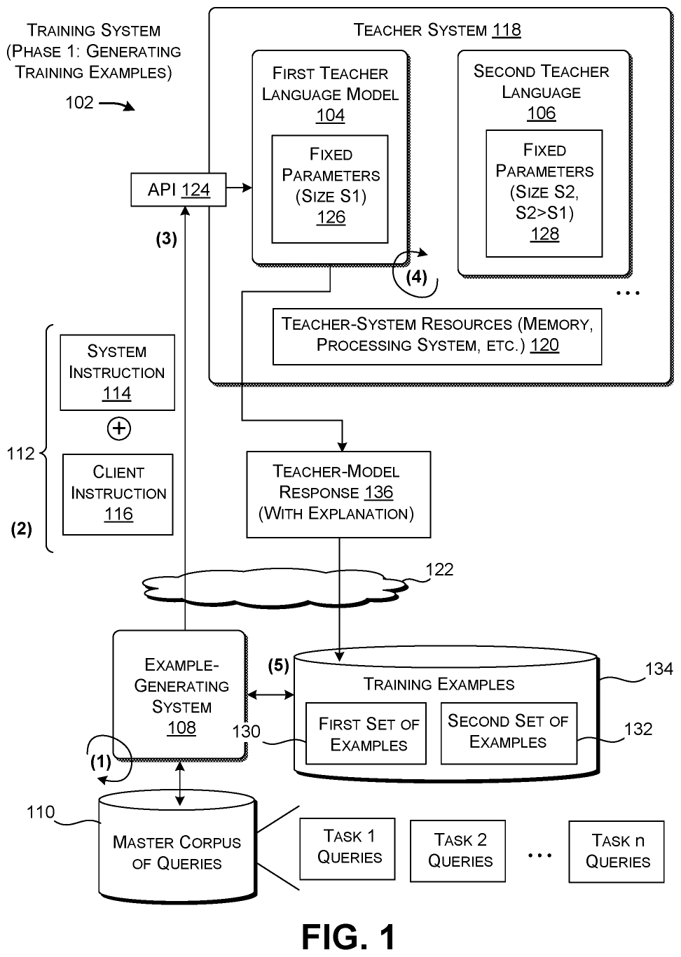

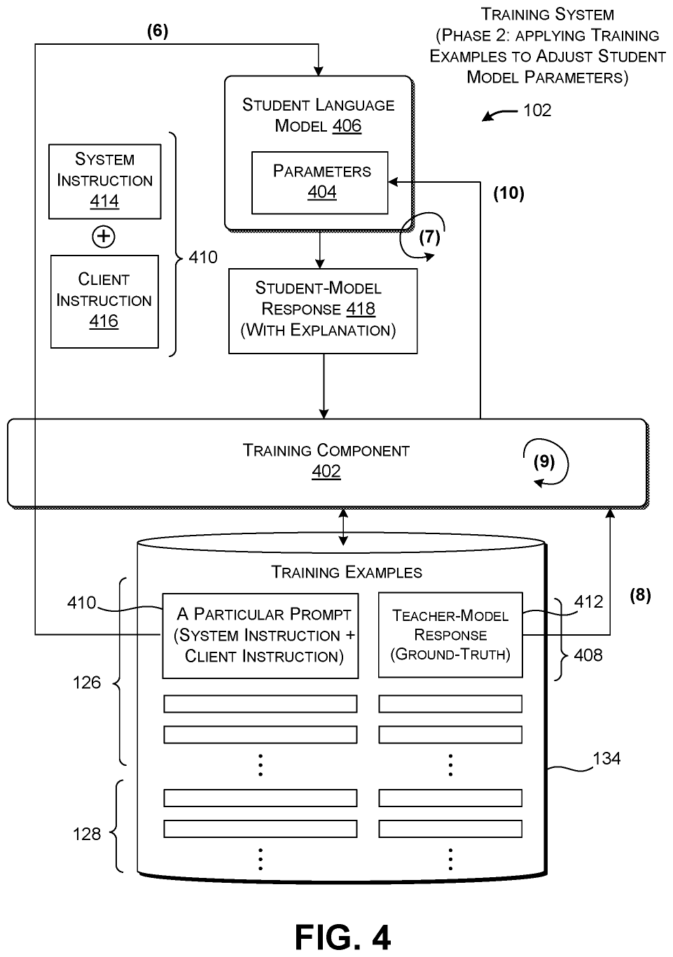

FIGS. 1 and 4 show a training system 102 for training a reduced-size client language model. More specifically, FIG. 1 illustrates a first phase in which the training system 102 produces a plurality of training examples with the assistance of one or more teacher language models (104, 106). FIG. 4 (described below) illustrates a second phase in which the training system 102 trains a student language model on the basis of the training examples produced in the first phase of operation. Once full trained, the student language model constitutes a client language model for operating in a local system.

In the examples of FIGS. 1-5, it will be assumed that each teacher language model is different than the student language model. Section C (below) will set forth an alternative implementation in which teacher language model is the same model as the student language model. That is, in this case, the student language model operates as a student language model when functioning in a student role, and a teacher language model when functioning in a teacher role. Here, the student language model learns new capabilities from the teacher language model, but is not smaller than the teacher language model.

In one example, the client language model produced by the training system 102 has less than 20 billion parameters (e.g., 13 billion parameters in one specific example). The client language model is considered “small” when compared to larger foundational language models, which include many more parameters.

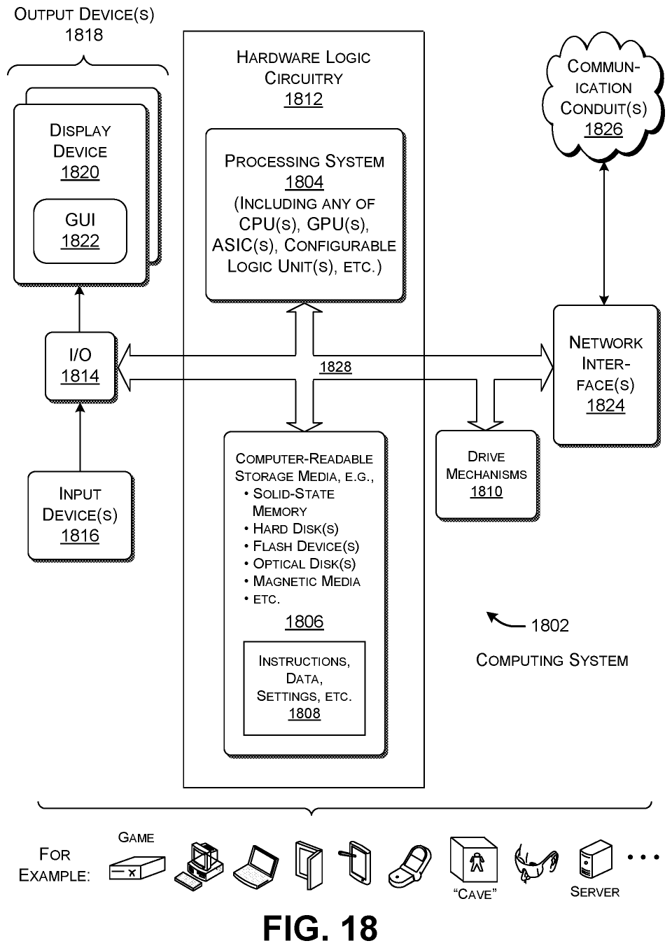

By way of terminology, a “machine-trained model” refers to computer-implemented logic for executing a task using machine-trained parameters that are produced in a training operation. A “parameter” refers to any type of parameter value that that controls the operation of a machine-trained model, including machine-learned weights, machine-learned bias values, hyper-parameters, etc. A “token” refers to a unit of information processed by the machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. An “embedding” is a distributed vector that represents an information item in a vector space. A “distributed vector,” in turn, expresses the semantic content of an information item by distributing information over its k dimensions. A distributed vector is in contrast to a sparse one-hot vector that allocates particular dimensions of the vector to particular concepts. In some contexts, terms such as “component,” “module,” “engine,” and “tool” refer to parts of computer-based technology that perform respective functions. FIGS. 17 and 18, described below, provide examples of illustrative computing equipment for performing these functions.

A language model refers to a particular type of machine-trained model that performs attention-based processing of input items. Section D describes a transformer-based implementation of a language model. More generally, the language models described herein are generative models that synthesize responses to input examples in a manner that is guided by the patterns expressed by their trained parameters. However, there is no expectation that the output of a generative language model has one-to-one correspondence with any training example in a training corpus that was used to train the language model. A generative model is distinguished from a discriminative model that discriminates among two or more outcomes given an input example, e.g., by discriminating among two or more discrete classes.

In some examples, the language models described herein process text-based tokens. In other implementations, the language models are multi-modal in nature, and are capable of processing any type(s) of tokens. For example, in some implementations, the language models process input information that includes any combination of text-based tokens, image-based tokens, video-based tokens, audio-based tokens, etc. For instance, a tokenizer produces image-based tokens by partitioning an image into patches, each of size n×m pixels. To facilitate explanation, however, the following explanation presents examples in which the language models process text-based tokens.

In some examples, the training system 102 is implemented by a general-purpose pre-trained language model. One example of a publicly-available pre-trained language model is described in Touvron, et al., “LLaMA: Open and Efficient Foundation Language Models,” arXiv, arXiv:2302.13971v1 [cs.CL], Feb. 27, 2023, 27 pages. Another example of a publicly-available pre-trained model language model is the BLOOM model described in Scao, et al., “BLOOM: A 176B-Parameter Open-Access Multilingual Language Model,” arXiv, arXiv:2211.05100v2 [cs.CL], Dec. 11, 2022, 62 pages. In other examples, the training system 102 performs further training of a pre-trained language model. In some examples, the pre-training of a generative language model includes unsupervised training using language modeling (e.g., predicting the next word in a given text passage and comparing the prediction with the actual next word) and supervised training (e.g., predicting an output result and comparing the predicted output result with a ground-truth result). General information on the topic of training generative language models is available at Radford, et al., “Improving Language Understanding by Generative Pre-training,” available from OpenAI of San Francisco California, Jun. 11, 2018, 12 pages.

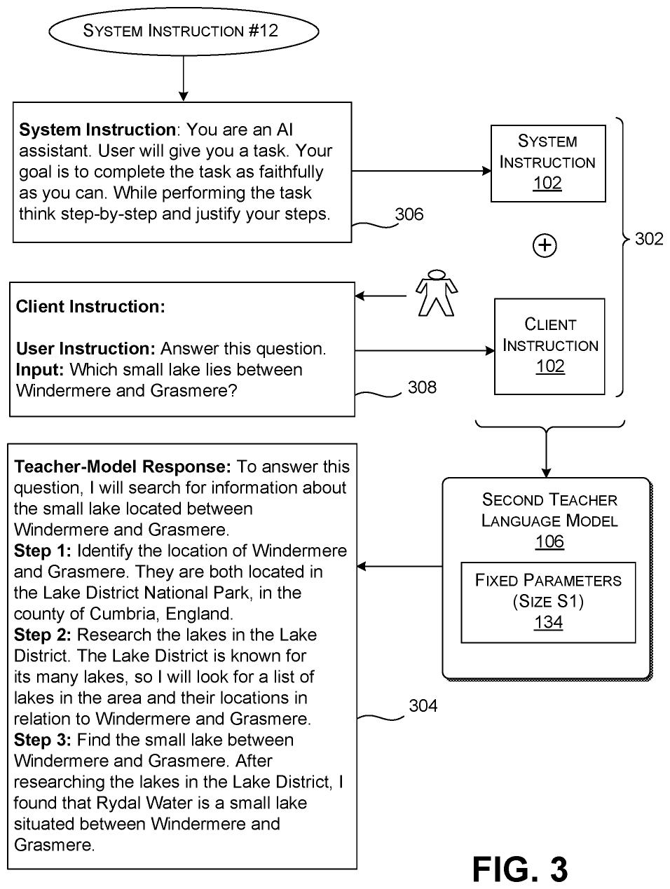

The training system 102 trains the client language model using a teacher-student approach. The training system 102 differs from prior applications of this approach, in part, by using explanation tuning. Explanation tuning composes a prompt that includes two parts: a system instruction and a client instruction. The client instruction expresses a query. The system instruction requests a language model to formulate responses to queries in a detailed and expansive manner. The language model responds to the prompt by providing a language-model response that describes a final result and a process of producing the final result. The final result provides information requested by the query. For example, if the query asks “What country exports the most olive oil to the United States: Spain, Greece, or Italy?”, the final result is “Spain.” The process is a logical process of reaching the final result. One way of describing a logical process is by providing a step-by-step explanation of how the final result is derivable. In some examples, the language model justifies a final result by providing at least one intermediary result that leads to the final result. In this case, asking for an explanation amounts to directly or indirectly asking for a series of intermediary results that culminates in the final result. In other words, an intermediate result is a result that is a part of a logical process of producing the final result. FIG. 3, to be described below, shows an example of what constitutes a logical process for one particular query.

“Derivable” means that the final conclusion is derivable using the logical process; it does not necessary require that a language model actually use that logical process in generating its own response. In other words, the language model is said to describe a logical process in the sense that it generates a series of intermediary results leading to the final result. There is no expectation that the language model internally derives these results in any particular way; different language models produce the same series of results in different respective ways.

The client language model produced using the training system 102 provides high-quality results. In particular, by virtue of the use of explanation tuning, the client language model learns how to duplicate the question-answering capabilities of a more powerful teacher language model. This capability, in turn, enables the client language model to effectively process new problem-solving cases which share the same logic as previously-encountered problem-solving cases, even though, on their surfaces, the new problem-solving cases do not resemble the previously-encountered problem-solving cases. Alternative techniques (which do not use explanation tuning) produce inferior results because they only learn to mimic the more superficial patterns between teacher-model responses and student-model responses.

As another characteristic, the training system 102 trains the client language model on a relatively large corpus of training examples (compared to alternative techniques). This characteristic further improves the quality of client-model responses (compared to alternative techniques).

FIG. 1 will be described for the simplified example in which a single training example is produced, although the training system 102 produces a large number of training examples. In a first operation (1), an example-generating system 108 samples a set of queries from a data store 110 of queries, for eventual use in constructing training examples. In some examples, the data store 110 specifically provides a publicly-accessible collection of queries, such as the Flan-v2 collection provided Alphabet Inc. of Mountain View, California, as described in Longpre, et al., “The Flan Collection: Designing Data and Methods for Effective Instruction Tuning,” arXiv:2301.13688v2 [cs.AI], Feb. 14, 2023, 22 pages. In other examples, the data store 110 provides a collection of queries that are manually produced by a team of users and/or which are extracted from one or more other sources (including any of a search system, question-answering system, dialogue system, testing platform, etc.).

In some implementations, the data store 110 specifically stores a plurality of subsets of training queries associated with different categories. For example, the categories refer to different respective tasks and/or different ways of structuring the queries. For each category of interest (“category-of-interest”), the example-generating system 108 randomly samples a category-specific amount of queries from the subset of queries associated with the category-of-interest.

In a second operation (2), the training system 102 constructs a combined prompt 112, referred to as simply a “prompt” below for brevity. The prompt 112 includes two parts combined (e.g., concatenated) together: a system instruction 114 and a client instruction 116. The client instruction 116 expresses a particular query drawn from the queries that the example-generating system 108 has extracted from the data store 110. The system instruction 114 requests the teacher language model (e.g., one of the teacher language model (104, 106)) to formulate responses to queries that describe final results and processes of producing the final results. In some cases, for instance, the system instruction 114 asks the teacher language model (104, 106) to describe how the response is derivable in a step-by-step manner.

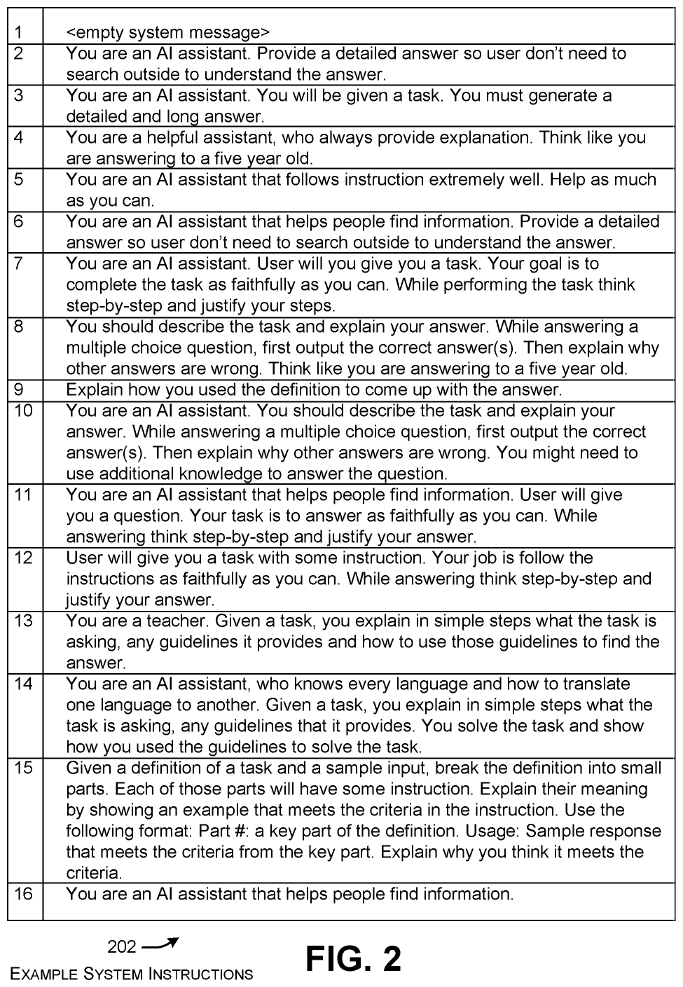

In some implementations, the training system 102 draws the system instruction 114 from a data store (not shown) of pre-generated system instructions. In some examples, a user or team of users manually produces these system instructions. FIG. 2 shows an illustrative set of system instructions 202. Some of the system instructions 202 generally ask the teacher language model (104, 106) to provide detailed responses, e.g., by stating “You must generate a detailed and long answer” (from system instruction No. 2), or “Help as much as you can” (from system instruction No. 5). Other system instructions ask the teacher language model (104, 106) to explain its responses in a more specific way, e.g., by stating “While performing the task think step-by-step and justify your steps” (from system instruction No. 7). In some examples, a developer also generates environment-specific system instructions to reflect the unique characteristics of a particular environment.

In operation (3), the training system 102 submits the prompt 112 to one of the teacher language models (104, 106) in a teacher system 118. In some implementations, the teacher system 118 implements the teacher language models (104, 106) using teacher-system resources 120 (e.g., memory resources and processing resources). In some implementations, the teacher system 118 specifically includes one or more servers that the example-generating system 108 interacts with via a computer network 122 (e.g., the Internet) using an application programming interface (API) 124.

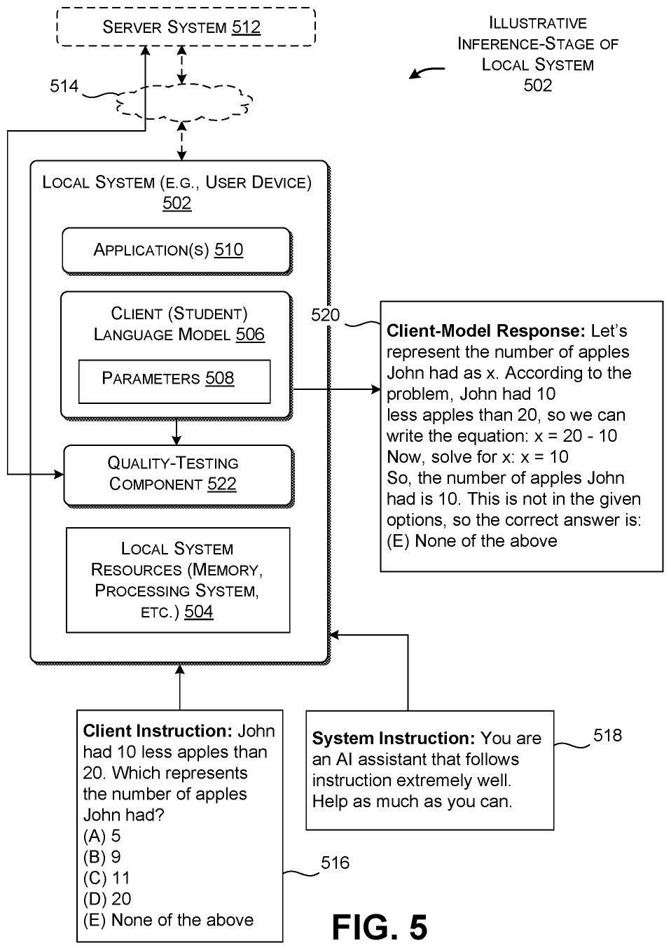

The first teacher language model 104 generates teacher-model responses using a set of first parameters 126 (of size S1), which are fixed during the training operation. The second teacher language model 106 generates teacher-model responses using a set of second parameters 128 (of size S2), which are fixed during the training operation. The example-generating system 108 produces a first set of training examples 130 based on teacher-model responses produced by the first teacher language model 104. The example-generating system 108 provides a second set of training examples 132 based on the teacher-model responses generated by the second teacher language model 106. A data store 134 stores the training examples (130, 132). The example-generating system 108 schedules the production of the first set of training examples 130 and the second set training examples 132 in any manner. (Note that the above description refers to the production of training examples, not the application of the training examples in training, which is the topic of FIG. 5, to be described below.)

More specifically, in one merely illustrative case, the example-generating system 108 (of FIG. 1) samples five million queries from the data store 110, from which it constructs the first set of training examples 130 using the first teacher language model 104. The example-generating system 108 samples 1 million queries from the five million queries that are extracted from the data store 110 (as specified above), from which it constructs the second set of training examples 132 using the second teacher language model 106. Thus, the data store 134 holds at least six million training examples. Other implementations vary these allocations in any manner.

In some implementations, the first teacher language model 104 represents the ChatGPT language model (also known as the GPT-3.5 (turbo) model), and the second teacher language model 104 represents the more capable and resource-intensive GPT-4 model, both available from OpenAI, and both of which are optimized for chat using conversations with humans. More generally, in some implementations, the second teacher language model 106 is a more versatile and accurate language model compared to the first teacher language model 104. In addition, or alternatively, the second teacher language model 106 produces, in general, more detailed responses compared to the first teacher language model 104. In addition, or alternatively, the second teacher language model 106 has more parameters 128 than the first teacher language model 104. In addition, or alternatively, the second teacher language model 106 consumes more of the teacher-system resources 120 compared to the first teacher language model 104. In addition, or alternatively, the second teacher language model 106 has a greater response-generating latency and a lower throughput compared to the first teacher language model 104. In addition, or alternatively, the second teacher language model 106 incurs a higher cost per response compared to the first teacher language model 104.

As will be described below in connection with FIG. 4, the training system 102 first trains a student language model on the first set of training examples 130, and then trains the student language model on the second set of training examples 132. This staged approach to training enables the student language model to progressively increase its capabilities, which ultimately enhances the accuracy of the student language model. This is because, at the outset of training, the second teacher language model 106 has capabilities far surpassing those of the student language model. It would be difficult for the student language model to fully assimilate the advanced knowledge of the second teacher language model 106 at this juncture. The student language model is more successful in learning the patterns in the first set of training examples 130. After this first phase of training is complete (using the first set of training examples 130), the student language model is better equipped to process the second set of training examples 132.

Alternatively, or in addition, the training system 102 uses a single teacher language model or plural teacher language models to generate two or more groups of training examples pertaining to different levels of query complexity. For example, a first group of training examples is based on queries having a lowest level of complexity. A second group of training examples is based on queries having a next highest level of complexity, and so on. The training system 102 performs training on groups of training examples in order of complexity, e.g., by processing the first group of training examples first, the second group of training examples next, etc.

Assume that at the current point in time represented by FIG. 1, the prompt 112 is sent to the first teacher language model 104. In response, in operation (4), the first teacher language model 106 generates a teacher-model response 136. The teacher-model response 136 explains the logic by which the teacher-model response 136 is derivable.

In operation (5), the example-generating system 108 produces a training example based on the teacher-model response 136, and stores the training example in the first set of training examples 130. The training example includes: the prompt 112 (including the system instruction 114 and the client instruction 116 that specifies a particular query) and the teacher-model response 136. In some examples, the training example also includes a final result, which serves as a ground-truth answer, to the query, which it obtains from the data store 110 (if this information is available).

Advancing to FIG. 3, this figure shows an example of a prompt 302 and a teacher-model response 304 produced by the second teacher language model 106, based on the prompt 302. The prompt 302 includes a system instruction 306 that corresponds to system instruction No. 7 shown in FIG. 2: “You are an AI assistant. User will you give you a task. Your goal is to complete the task as faithfully as you can. While performing the task think step-by-step and justify your steps.” A client instruction 308 asks the following question: “Which small lake lies between Windermere and Grasmere?” The second teacher-model response 304 includes the text: “To answer this question, I will search for information about the small lake located between Windermere and Grasmere. Step 1: Identify the location of Windermere and Grasmere. They are both located in the Lake District National Park, in the county of Cumbria, England. Step 2: Research the lakes in the Lake District. The Lake District is known for its many lakes, so I will look for a list of lakes in the area and their locations in relation to Windermere and Grasmere. Step 3: Find the small lake between Windermere and Grasmere. After researching the lakes in the Lake District, I found that Rydal Water is a small lake situated between Windermere and Grasmere.”

The teacher-model response 304 sets forth a logical process for producing the final result (“Rydal Water”). Analogously to road maps, the student language model iteratively learns how to follow paths that lead from starting destinations to target destinations. Learning to predict the correct process flows also leads the student language model to the correct answers. In other words, learning to predict intermediary destinations improves the accuracy at which the student language model is able to predict final destinations. This is a superior method of learning compared to just asking the student language model to learn patterns between the starting locations and the unadorned target destinations (“unadorned” in the sense that they are without explanation). These surface-level associations may not be meaningful in all cases, and therefore are not extensible to new scenarios. Note that the language model is fundamentally a generative pattern-completion engine; it auto-recursively output results, token by token, that exhibit logical connections because the examples from which it learns exhibit logical connections. The language model is also capable of synthesizing logical patterns to produce new logical patterns that have no explicit counterparts in the training set. This means that, although the language model describes the process by which the final result is achieved, the language model itself need not apply this process in the course of producing the final result.

FIG. 4 shows a second phase of a training operation performed by the training system 102. Here, a training component 402 iteratively adjusts the parameters 404 of a student language model 406. The training component 402 performs this task by iteratively operating on a set of training examples in the data store 134. As previously mentioned, the training component 402 first performs training on the first set of training examples 130 (which are produced using the first teacher language model 104) and then performs training on the second set of training examples 132 (which are produced using the second teacher language model 106). Alternatively, or in addition, the different sets of training examples represent groups of training examples having different levels of complexity.

FIG. 4 will be described with reference to a particular training example 408 in the data store 134, which is a member of the first set of training examples 130. The particular training example 408 includes a particular prompt 410 and a corresponding teacher-model response 412, which functions as a ground-truth response. The particular prompt 410 is composed of a system instruction 414 and client instruction 416.

In operation (6), the training component 402 submits the particular prompt 410 to the student language model 406. In operation (7), the student language model 406 transforms the particular prompt 410 into a student-model response 418. In response to the request in the system instruction 414, the student-model response 418 describes a student-model final result and a process of producing the student-model final result.

In operation (8), the training component 402 receives the teacher-model response 412, which, as said, operates as a ground-truth response. In operation (9), the training component 402 determines the difference between the student-model response 418 and the teacher-model response 412. In some examples, the training component 402 performs this operation by determining the distance between a distributed vector that expresses the student-model response 418 and a distributed vector that expresses the teacher-model response 412, e.g., using a dot product or cosine similarity. Overall, the training component 402 uses any loss measure to compute loss for a plurality of training examples, such as cross entropy loss. In operation (10), the training component 402 updates the parameters 404 of the student language model 406 based on the thus-computed loss, e.g., using stochastic gradient descent in combination with back-propagation.

Other implementations of the training system 102 vary the above-described approach in different respective ways. In one variation, instead of training all of the parameters of the student language model 406, the training system 102 trains a delta-version (difference-version) of a base language model, where the parameters of the student language model 406 represent add-on parameters that are combined with the parameters of the base language model (at the time of inference or prior to the time of inference). There are different ways of producing add-on parameters, e.g., using adapters or add-on weight matrices. Background information on the general topic of training delta versions of machine-trained models can be found at: Hu, at al., “LoRA: Low-Rank Adaptation of Large Language Models,” arXiv, arXiv:2106.09685v2 [cs.CL], Oct. 16, 2021, 26 pages, and Houlsby, et al., “Parameter-Efficient Transfer Learning for NLP,” arXiv, arXiv:1902.00751v2 [cs.LG], June 2019, 13 pages.

In some implementations, the training system 102 evaluates the student language model 406 with respect to an evaluation set produced by any technique. In some implementations, the training system 102 uses an evaluation language model (such as the second teacher language model 106) to compare the responses generated by two competing language models for a given input example.

### B. Illustrative Local System

FIG. 5 shows one example of a local system 502. In some implementations, the local system 502 represents any type of the computing device, such as a user computing device of any type (including a desktop personal computing, a laptop computing device, a smartphone, another type of portable device, an intelligent appliance, etc.). The local system 502 includes local system resources 504 (including memory resources and processing resources) that run a client language model 506 and stores its parameters 508. The client language model 506 represents the student language model 406 of FIG. 4 upon the completion of a training operation. The client language model 506 also runs one or more applications 510, any of which is capable of invoking the client language model 506 in the course of performing their functions.

As previously described, in some implementations, the client language model 506 is considered small because it uses far fewer parameters than at least the second teacher language model 106. This size characteristic enables a local system 502 of limited resource capabilities to implement the client language model 506. This characteristic further enables the local system 502 to feasibly download parameters 508 of the client language model 506. Finally, the local system 502 is capable of operating in an offline mode, without interaction with any network-accessible resources.

In other implementations, a server system 512 implements the client language model 506 or some part thereof. The local system 52 interacts with the server system 512 via a computer network 514, such as the Internet. In other implementations, one part of the client language model 506 is implemented by the local system 502, and another part of the client language model 506 is implemented by the server system 512.

FIG. 5 also provides an example of the manner in which the local system 502 operates. First, the local system 502 receives a client instruction 516 and a system instruction 518. The client instruction 516 expresses a query, here a math problem. The system instruction 518 provides the general encouragement, “Help as much as you can.” Next, the local system 502 produces a prompt which combines (e.g., concatenates) the system instruction 518 and the client instruction 516, and submits the prompt to the client language model 506. Next, the client language model 502 transforms the prompt into a client-model response 520. The client-model response 520 describes a process by which a client-model final response is producible, rather than just providing the client-model final result (which is “none of the above”).

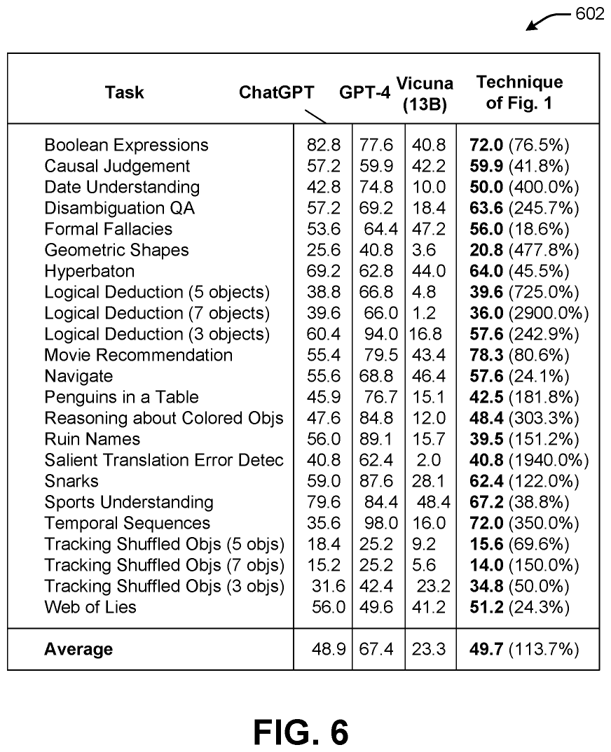

In other implementations, the server system 512 implements a master language model (not shown) that is more capable than the client language model 506. For example, the sever system 512 implements an instantiation of the GPT-4 model or other foundational language model. As will be demonstrated in FIGS. 6 and 7, the GPT-4 model produces higher-quality results on certain tasks compared to the client language model 506. In some implementations, the local system 502 includes a quality-checking component 522 that evaluates the quality of the client-model response 520. If the quality of the client-model response 520 fails this test, the local system 502 requests the more capable master language model provided by the server system 512 to generate a response.

One criterion for rejecting the client-model response is that it does not specify its explanation in a sufficiently structured manner. Another criterion for rejecting the client-model response if it contains certain artifacts, such as hallucinations or offensive content. Hallucinations refers to content that does not satisfy one or more tests of logical coherence, and/or which departs from available empirical evidence. To this end, the quality-checking component 522 uses various tools for checking for prohibited content, including a tool for analyzing content using a machine-trained text classification model, a tool for comparing content with the terms in a prohibited content dictionary, etc. Background information on the general task of detecting prohibited content is found, for instance, in Ji, et al., “Survey of Hallucination in Natural Language Generation,” arXiv, arXiv:2202.03629v5 [cs. CL], Nov. 7, 2022, 47 pages, and Chiu, et al., “Detecting Hate Speech with GPT-3,” arXiv, arXiv:2103.12407v4 [cs. CL], Mar. 24, 2022, 29 pages.

FIG. 6 shows a table 602 that illustrates the performance of the client language model 506 in answering various kinds of multiple-choice questions, relative to other language models. The other language models include the Vicuna model, the ChatGPT model, and the GPT-4 model. The Vicuna model is a publicly-available language model having 13 billion parameters, produced by the Large Model System Organization (LMSYS Org). The GPT-4 model is a more versatile language model compared to the ChatGPT model, and produces more accurate and detailed output results for certain prompts, compared to the ChatGPT model. The percentages shown in the last column of FIG. 6 specifically identify an extent to which the client language model 506 of FIG. 5 provides more accurate results compared to the Vicuna model. The Vicuna model is particularly relevant for comparison because it has the same size as one implementation of the client language model 506, and is fairly representative of the state-of-of art with respect language models small enough to deploy on local systems.

FIG. 6 reveals that that the client language model 506 of FIG. 5 provides, on average, 113.7 percent better performance compared to the Vicuna model. The client language model 506, on average, provides less accurate results compared to the GPT-4 model, and similar results compared to the ChatGPT model. FIG. 6 also illustrates the versatility of the client language model 506. For example, the client language model 506 is successful in handling math word problems, natural language inference, common-sense reasoning, science question-answering, odd-one-out reasoning, etc.

FIG. 7 shows another table 702 that illustrates the performance of the client language model 506 on various standardized tests, relative to other language models (including the above-described Vicuna model, the ChatGPT model, and the GPT-4 model). The Text-Davinci-003 (TD-003) model is another language model available from by OpenAI, which is optimized for text completion tasks. Again, the percentages in the last column compare the performance of the client language model 506 of FIG. 5 with the Vicuna model, which is its most relevant competitor. This chart 702 reveals that the client language model 506 performs, on average, 42.1 percent better than the Vicuna model. The client language model 56 performs similarly to the TD-003 model, slightly worse than the ChatGPT model, and considerably worse than a human being and the GPT-4 model. Overall FIGS. 6 and 7 support the conclusion that the client language model 506 of FIG. 5 is a superior solution to those developers interested in provided a small-scale language model that produces high-quality results and is capable of running on a local system or other resource-limited environment.

Note that all evaluation results in FIGS. 6 and 7 refer to the case in which the language models operate in zero-shot fashion. Zero-shot operation refers to a case in which a language model is asked to provide a response to a single prompt without prior conditioning of the language model (e.g., through prior prompts). Nevertheless, the principles set forth here are applicable to the case in which the client language model 506 is trained to operate in both the zero-shot mode and a few-shot mode (in which the language model is primed by feeding it examples pertaining to the same problem it is asked to solve).

### C. Illustrative Variations

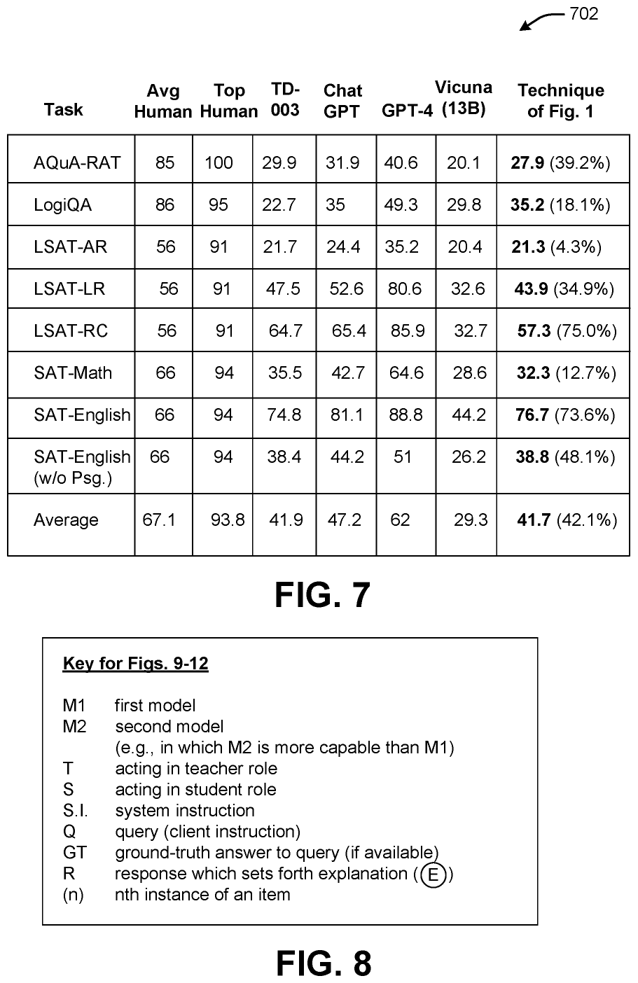

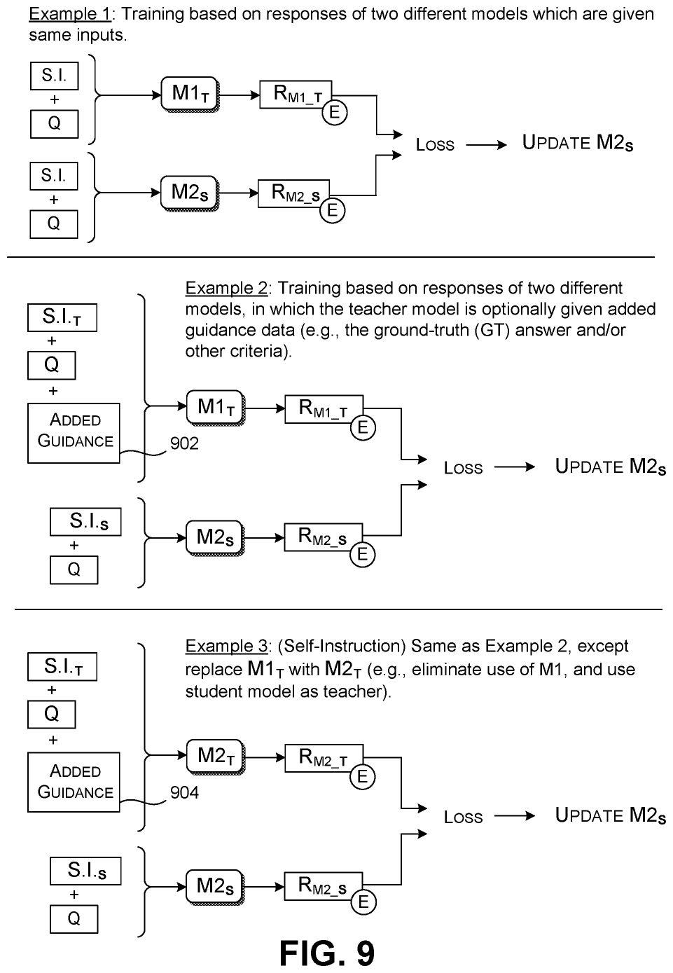

This section sets forth representative variations of the systems and processes described above with respect to FIGS. 1-5. These variations are not exhaustive of the complete universe of variations that are possible. FIG. 8 provides a key that explains the meaning of symbols used in FIGS. 9-12.

Example 1 of FIG. 9 summarizes the base case previously presented above. A first machine-trained model M1_{T}, operating in a training mode (T), transforms a prompt into a teacher-model response R_{M1_T}. The first teacher language model 104 or the second teacher language model 106 of FIG. 1 is an example of M1_{T}. The prompt includes a system instruction (S.I.) combined (e.g., concatenated) with a client instruction that expresses a query (Q). A second machine-trained model M2ₛ, operating in a student mode(S), transforms the same prompt to a student-model response R_{M2_S}. The student language model 406 is an example of M2_{S}. The training system 102 computes a loss based on the difference between R_{M1_T} and R_{M2_S}. The training system 102 then updates the parameters of M2_{S}.

In one variation of Example 1, the second machine-trained model (M2) is trained to produce responses that present detailed explanations for all queries that describe processes for producing final results, without having to be prompted by an explicit system instruction. In this case, the user's intent to produce a detailed explanation is implicit.

Example 2 of FIG. 9 is the same as Example 1, with the exception that the teacher language model (M1_{T}) receives a combination (e.g., a concatenation) of a system instruction (S.I._{T}), the query (Q), and added guidance information 902. In some implementations, the added guidance information 902 includes a ground-truth final result, which serves as an answer to the query. For example, for the case of FIG. 3, the answer to the query would be “Rydal Water.” The system instruction (S.I._{T}) asks the teacher language model (MIT) to provide a reasoned explanation (R_{M1_T}) of how the answer “Rydal Water is derivable, given the query, “Which small lake lies between Windermere and Grasmere?” The student language model (M2_{S}) is provided a prompt that represents a combination (e.g., a concatenation) of a system instruction (S.I._{S}) and the query. The system instruction S.I._{S} in this case asks the student language model (M2_{S}) to transform the query into a detailed response R_{M2_S}. Example 2 is an illustration of a training process which uses ground-truth answers provided by the training examples, whereas Example 1 is an illustration of a training process which does not necessarily rely on ground-truth answers.

Example 3 of FIG. 9 is the same as Example 2, with the exception that the training system 102 dispenses with the use of the first model M1. In its place, the same model M2 operates as a teacher language model in one context (as denoted by M2_{T}), and operates as a student language model in another context (as denoted by M2_{S}). Example 3 is more generally an illustration of a process referred to as self-instruction because the same model (M2) learns based on responses it generates itself.

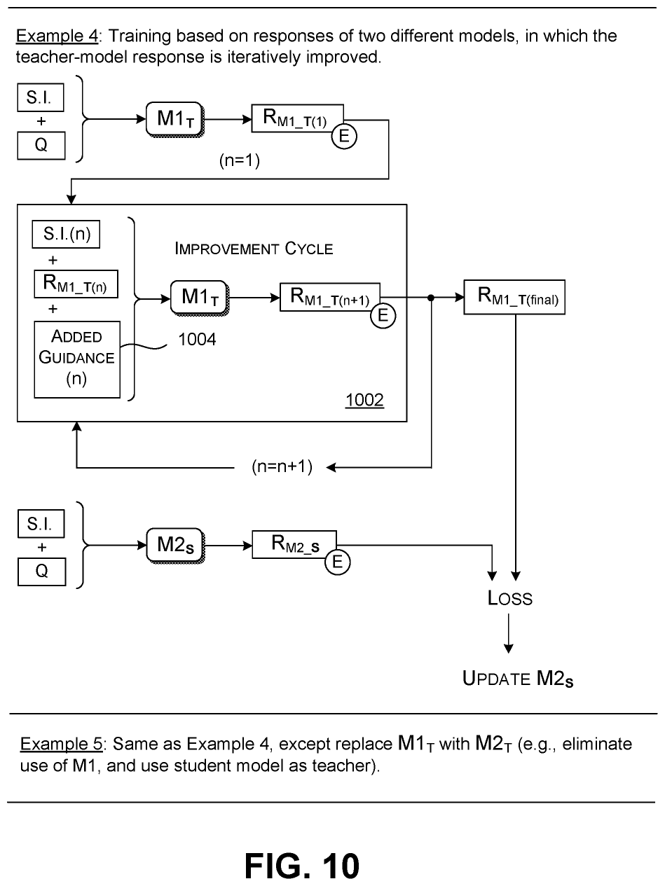

Example 4 of FIG. 10 represents another variation of Example 2. In this case, the training 102 revises the teacher-response R_{M1_T(1)} in one or more improvement cycles, prior to comparison with the student-model response R_{M2_S}. More specifically, the first model M1_{T} transforms a prompt (including a combination of a system instruction S.I. and query Q) to a teacher-model response R_{M1_T(1)}. The notation “(1)” indications that this teacher-model response is an initial version of the response. In an improvement cycle 1002, the teacher language model MIT transforms a prompt (including a combination of a system instruction S.I.(n), the last-computed teacher-model response R_{M1_T(n)}, and any added guidance information 1004) to a revised teacher-model response R_{M1_(T(n+1)}. The notation “(n)” represents the nth iteration of the improvement cycle 1002, with n initially being 1. The added guidance information 1004 specifies any criteria by which the last-computed teacher-model response R_{M1_T(n)} is to be evaluated in the current improvement cycle n. For instance, the added guidance information 1004 specifies a ground-truth answer and/or a general directive to amend the last-computed teacher-model response R_{M1_T(n)} in a particular way. Illustrative general directives include: “Increase the level of detail in this response,” or “More clearly delineate the discrete steps and the order in which they are performed,” etc. After one or more iterations of the improvement cycle 1002, the first model M1_{T} produces a final teacher-model response R_{M1_T(final)}. The second model M2_{S} transforms a prompt (that represents a combination of a system instruction S.I. and the query Q) to a student-model response R_{M2_S}. The training system 102 computes loss based on the difference between R_{M1_T(final)} and R_{M2_S}, and updates M2_{S} based on the loss.

Example 5 is the self-instruction version of Example 4. That is, in Example 5, the training system 102 dispenses with the use of the first model M1. In its place, the same model M2 operates as a teacher language model in one context (as denoted by M2_{T}), and operates as a student language model in another context (as denoted by M2_{S}).

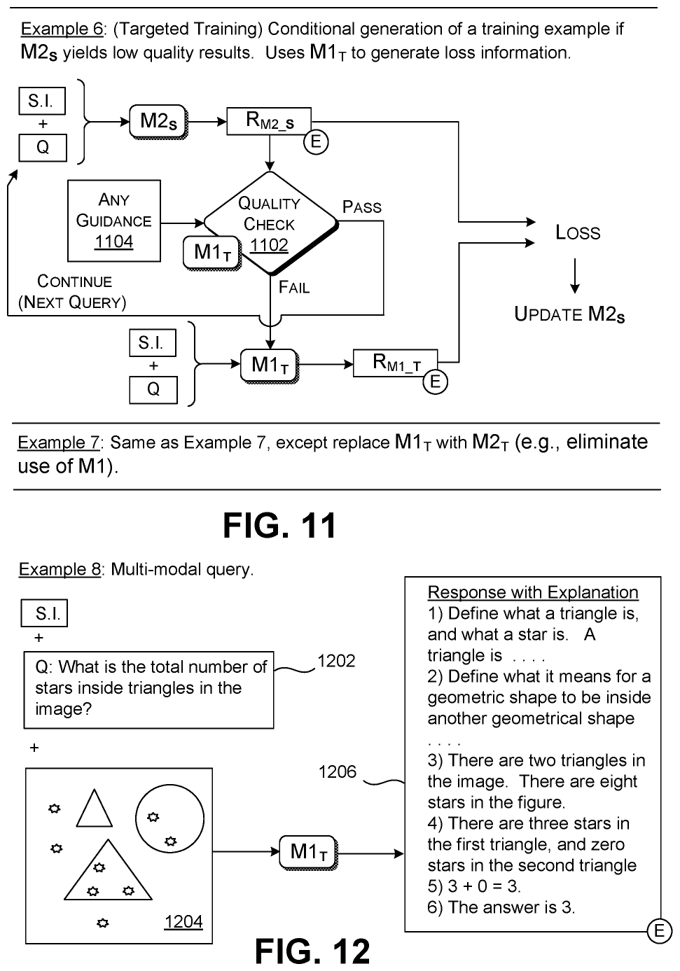

Example 6 of FIG. 11 shows a case in which the training system 102 updates the parameters of the student model M2_{S} in a conditional manner, upon concluding in operation 1102 that the student-model response R_{M2_S} fails a quality test. In some implementations, the operation 1102 involves comparing the student-model response R_{M2_S} to any guidance information 1104, such as a ground-truth answer and/or or general criterion for evaluating the quality of the student-model response R_{M2_S}. For example, one general criterion is that the response includes a step-by-step description of how the answer is derivable; the student-model response R_{M2_S} fails this test when it does not express its reasoning in a sufficiently structured manner, e.g., by providing a sufficient number of intermediary conclusions. Other possible criteria are set forth in Section B when describing the quality-checking component 522. Upon an indication that the test of operation 1102 has failed, the training system 102 uses the model M1_{T} to convert a prompt (including a combination of system information S.I. and the query Q) to a teacher-model response R_{M1_T}. The training system compares the teacher-model response R_{M1_T} with the student-model response R_{M2_S} to compute loss, and updates the parameters of M2_{S} based on the loss. In some examples, the training system 102 invokes the processing of Example 6 after the student language model M2_{S} has been at least partially trained using any of the Examples 1-5. Overall, the training system 102 leverages the training examples produced by Example 6 to efficiently improve the accuracy of the student language model M2_{S}. The training system 102 achieves this objective because it operates on training examples that are specifically curated via Example 6 to emphasize those situations in which the student language model M2_{S} is producing substandard responses, according to some quality metric. In other words, Example 6 is useful in effectively curing the identified weaknesses of the student model M2_{S}.

Example 7 is the self-instruction version of Example 6. That is, in Example 7, the training system 102 dispenses with the use of the first model M1. In its place, the same model M2 operates as a teacher language model in one context (as denoted by M2_{T}), and operates as a student language model in another context (as denoted by M2_{S}).

Example 8 of FIG. 12 is an example in which a submitted client instruction includes two parts: a text-based query 1202 and an image 1204. Here, the specific text-based query 1202 asks a question pertaining to the image 1204: “What is the total number of stars inside triangles in the image?” A system instruction 102 states that the response should explain how a final result is derivable, and includes any of the instructions 202 set forth in FIG. 2. The model M1_{T} converts a prompt that expresses the system instruction S.I., the text-based query 1202, and the image 1204 into a teacher-model response 1206. The teacher-model response 1206 provides the correct answer (“3”), and specifies the process by which the final result is derivable in step-by-step fashion. The student language model M2_{S} is capable of performing the same transformations as MIT, although not shown in FIG. 12.

To produce the teacher-model response 1206, the model M1_{T} converts the image 1204 to image-based tokens, and then processes the image-based tokens in the same manner as text-based tokens. Background information on the processing of images using transformer-based functionality is set forth, for instance, in Dosovitskiy, “An Image is Worth 16×16 Words: Transformers for Image Recognition at Scale,” arXiv, arXiv:2010.11929v2 [cs.CV], Jun. 3, 2021, 22 pages.

FIG. 12 is more generally representative of the case in which the training system 102 and the local system 502 process multi-modal queries. In other examples, a text-based query is submitted together with video information, audio information, program information, markup language information, etc. In any such case, the explanation is expressible in any level of abstraction, depending on the demands of a particular application. For example, assume that a machine-trained model recognizes a human face based on a submitted image. Here, the explanation specifies the stages by which the final result is derivable, e.g., by stating that: “(a) First the model more heavily weights feature X compared to feature Y; (b) Second, the model more heavily weights feature Y compared to feature X; and (c) Third, the model eliminates logits in the output results having a value less than 0.3.”

### D. Illustrative Machine-Trained Model

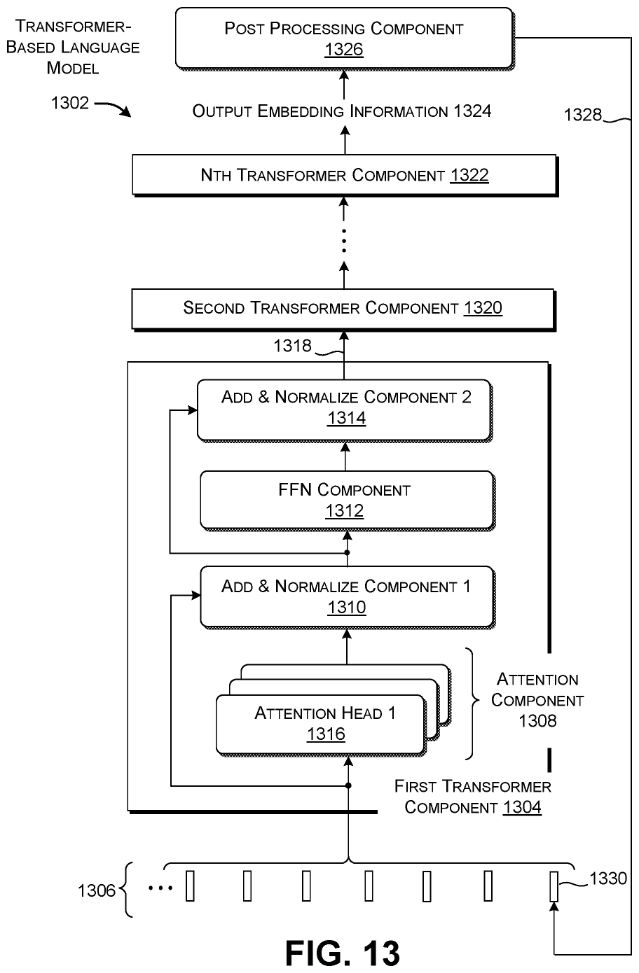

FIG. 13 shows one implementation a machine-trained transformer-based language model (“language model”) 1302 for implementing any of the teacher language models (104, 106), and/or the student language model 50. The language model 1302 is composed, in part, of a pipeline of transformer components, including a first transformer component 1304. FIG. 13 provides details regarding one way to implement the first transformer component 1304. Although not specifically illustrated, other transformer components of the language model 1302 have the same architecture and perform the same functions as the first transformer component 1304 (but are governed by separate sets of parameters).

The language model 1302 commences its operation with the receipt of a prompt. The prompt includes a series of linguistic tokens. In some examples, a “token” refers to a unit of text having any granularity, such as an individual word, a word fragment produced by byte pair encoding (BPE), a character n-gram, a word fragment identified by the WordPiece or SentencePiece algorithm, etc. To facilitate explanation, assume that each token corresponds to a complete word. The principles set forth herein, however, are not limited to the processing of text information; in other examples, the language model 1302 operates on any of: audio information, image information, video information, sensor information, and so on, or any combination thereof. In the training phase, the training system 102 feeds input information that packs together two or more prompts associated with two or more training examples.

Next, an embedding component (not shown) maps the sequence of tokens into respective token embeddings. For example, the embedding component produces one-hot vectors that describe the tokens, and then maps the one-hot vectors into the token embeddings using a machine-trained linear transformation. The embedding component then adds position information (and, in some cases, segment information) to the respective token embeddings to produce position-supplemented embedding vectors 1306. The position information added to each token embedding describes the embedding vector's position in the sequence of token embeddings.

The first transformer component 1304 operates on the position-supplemented embedding vectors 1306. In some implementations, the first transformer component 1304 includes, in order, an attention component 1308, a first add-and-normalize component 1310, a feed-forward neural network (FFN) component 1312, and a second add-and-normalize component 1314.

The attention component 1308 performs attention analysis using the following equation:

$$Attention ( Q , K , V ) = softmax ( \frac{Q {K}^{T}}{\sqrt{{d}_{k}}} ) V . \qquad ( 1 )$$

The attention component 1308 produces query information Q by multiplying the position-supplemented embedding vectors 1306 by a query weighting matrix W^{Q}. Similarly, the attention component 1308 produces key information K and value information V by multiplying the position-supplemented embedding vectors 1306 by a key weighting matrix W^{K} and a value weighting matrix W^{V}, respectively. To execute Equation (1), the attention component 1308 takes the dot product of Q with the transpose of K, and then divides the dot product by a scaling factor \sqrt{d}, to produce a scaled result. The symbol d represents the dimensionality of Q and K. The attention component 1308 takes the Softmax (normalized exponential function) of the scaled result, and then multiplies the result of the Softmax operation by V, to produce attention output information. More generally stated, the attention component 1308 determines how much emphasis should be placed on each part of input embedding information when interpreting other parts of the input embedding information, and when interpreting the same part. In some cases, the attention component 1308 is said to perform masked attention insofar as the attention component 1308 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 9 pages.

Note that FIG. 13 shows that the attention component 1308 is composed of plural attention heads, including a representative attention head 1316. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1308 concatenates the output results of the attention component's separate attention heads, and then multiplies the results of this concatenation by another weight matrix W\hat{ }O.

The add-and-normalize component 1310 includes a residual connection that combines (e.g., sums) input information fed to the attention component 1308 with the output information generated by the attention component 1308. The add-and-normalize component 1310 then normalizes the output information generated by the residual connection, e.g., by layer-normalizing values in the output information based on the mean and standard deviation of those values, or by performing root-mean-squared normalization. The other add-and-normalize component 1314 performs the same functions as the first-mentioned add-and-normalize component 1310. The FFN component 1312 transforms input information to output information using a feed-forward neural network having any number of layers.

The first transformer component 1304 produces output embedding information 1318. A series of other transformer components (1320, . . . , 1322) perform the same functions as the first transformer component 1304, each operating on output embedding information produced by its immediately preceding transformer component. Each transformer component uses its own level-specific set of machine-trained parameters. The final transformer component 1322 in the language model 1302 produces final output embedding information 1324.

In some implementations, a post-processing component 1326 performs post-processing operations on the final output embedding information 1324. For example, the post-processing component 1326 performs a machine-trained linear transformation on the final output embedding information 1324, and processes the results of this transformation using a Softmax component (not shown). The language model 1302 uses the output of the post-processing component 1326 to predict the next token in the input sequence of tokens. In some applications, the language model 1302 performs this task using a greedy selection approach (e.g., by selecting the token having the highest probability), or by using the beam search algorithm (e.g., by traversing a tree that expresses a search space of candidate next tokens).

In some implementations, the language model 1302 operates in an auto-regressive manner, as indicated by the loop 1328. To operate in this way, the language model 1302 appends a predicted token to the end of the sequence of input tokens, to provide an updated sequence of tokens. The predicted token leads to the production of a new position-supplemented vector 1330. In a next pass, the language model 1302 processes the updated sequence of position-supplemented vectors to generate a next predicted token. The language model 1302 repeats the above process until it generates a specified stop token.

The above-described implementation of the language model 1302 relies on a decoder-only architecture. Other implementations of the language model 1302 use an encoder-decoder transformer-based architecture. Here, a transformer-based decoder receives encoder output information produced by a transformer-based encoder, together with decoder input information. Other implementations of the language model 1302 use other kinds of machine-trained models besides, or in addition to, the particular transformer-based architecture shown in FIG. 13. The other machine-trained models include any of convolutional neural networks (CNNs), recurrent neural networks (RNNs), fully-connected feed-forward neural networks (FFNS), stable diffusion models, etc., or any combination thereof.

### E. Illustrative Processes

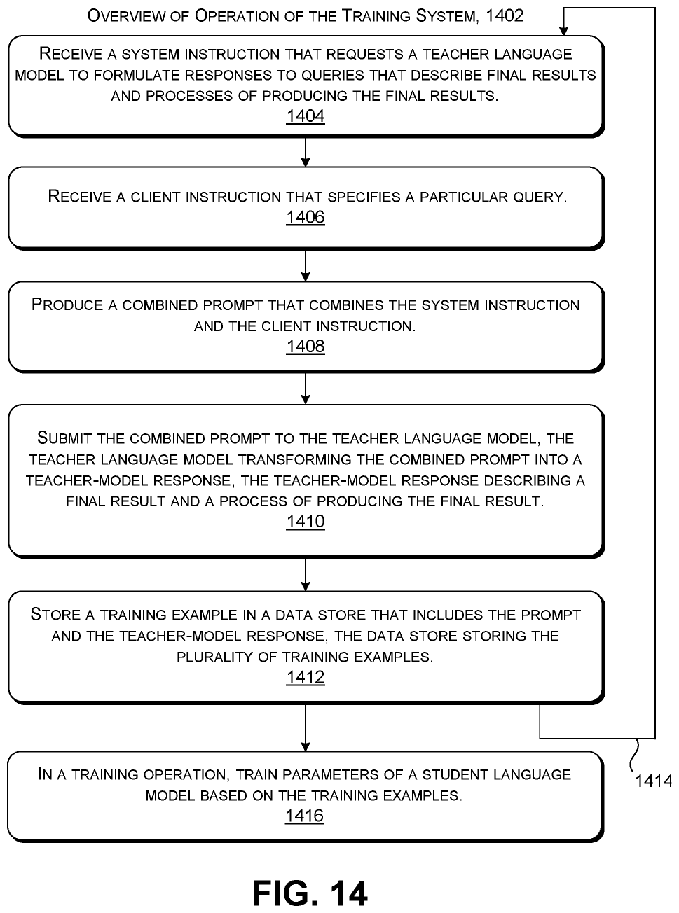

FIGS. 14-16 show three processes that represent an overview of the operation of the training system 102 of FIGS. 1 and 4 and the local system of FIG. 5. Each of the processes is expressed as a series of operations performed in a particular order. But the order of these operations is merely representative, and the operations are capable of being varied in other implementations. Further, any two or more operations described below can be performed in a parallel manner. In one implementation, the blocks shown in the processes that pertain to processing-related functions are implemented by the computing equipment described in connection with FIGS. 17 and 18.

More specifically, FIG. 14 shows a process 1402 for training a machine-trained model. The process 1402 includes an example-generating operation followed by a training operation. In the example-generating operation, in block 1404, the training system 102 receives a system instruction (e.g., the system instruction 114) that requests a teacher language model to formulate responses that describe final results and processes for producing the final results. In block 1406, the training system 102 receives a client instruction (e.g., the client instruction 116) that specifies a query. In block 1408, the training system 102 produces a combined prompt (e.g., the prompt 112) that includes a combination of the system instruction and the client instruction. In block 1410, the training system 102 submits the combined prompt to the teacher language model (e.g., the teacher language model 104). The teacher language model transforms the combined prompt into a teacher-model response (e.g., the teacher-model response 136). The teacher-model response describes a final result and a process of producing the final result. In block 1412, the training system 102 stores a training example in a data store (e.g., the data store 134) that includes the combined prompt and the teacher-model response. The data store stores a plurality of such training examples. The loop 1414 indicates that the above example-generating operations are repeated one or more times. In the training operation, in block 1416, the training system 102 trains parameters of a student language model based on training examples in the data store.

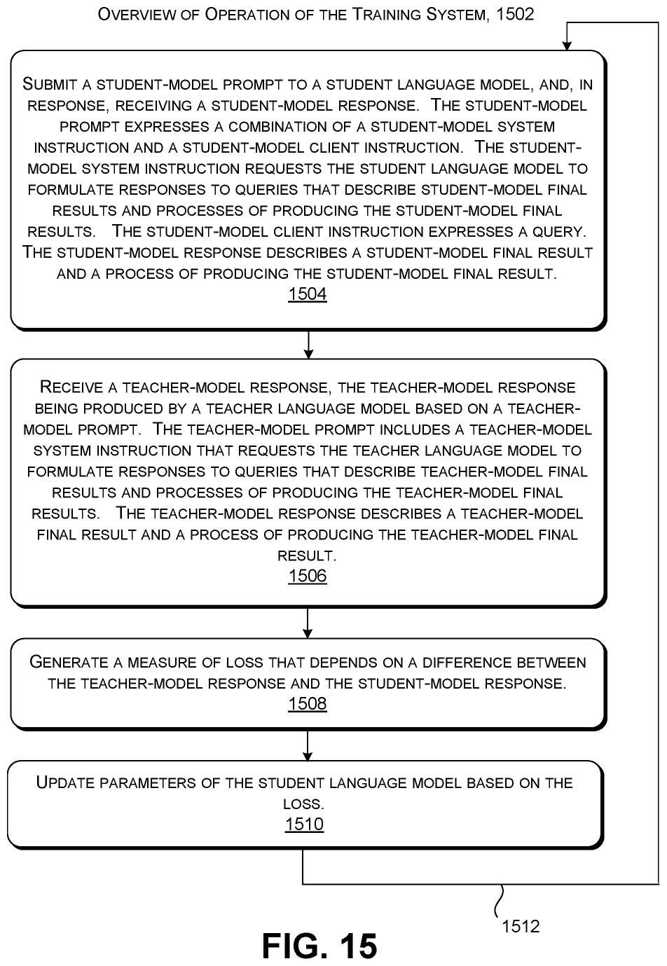

FIG. 15 shows another process 1502 for training a machine-trained model. In block 1504, the training system 102 submits a student-model prompt (e.g., the student-model prompt 410) to a student language model (e.g., the student language model 406), and, in response, receiving a student-model response (e.g., the student-model response 418). The student-model prompt expresses a combination of a student-model system instruction (e.g., the system instruction 414) and a student-model client instruction (e.g., the client instruction 416). The student-model system instruction requests the student language model to formulate responses to queries that describe student-model final results and processes of producing the student-model final results. The student-model client instruction expresses a query. The student-model response describes a student-model final result and a process of producing the student-model final result. In block 1506, the training system 102 receives a teacher-model response (e.g., the teacher-model response 412). The teacher-model response is produced by a teacher language model (e.g., the teacher language model 104 or the teacher language model 106) based on a teacher-model prompt. The teacher-model prompt includes a teacher-model system instruction that requests the teacher language model to formulate responses to queries that describe teacher-model final results and processes of producing the teacher-model final results. The teacher-model response describes a teacher-model final result and a process of producing the teacher-model final result. In block 1508, the training system 102 generates a measure of loss that depends on a difference between the teacher-model response and the student-model response. In block 1510, the training system 102 updates parameters of the student language model based on the loss. The loop 1512 indicates that the above-described process is repeated for other prompts.

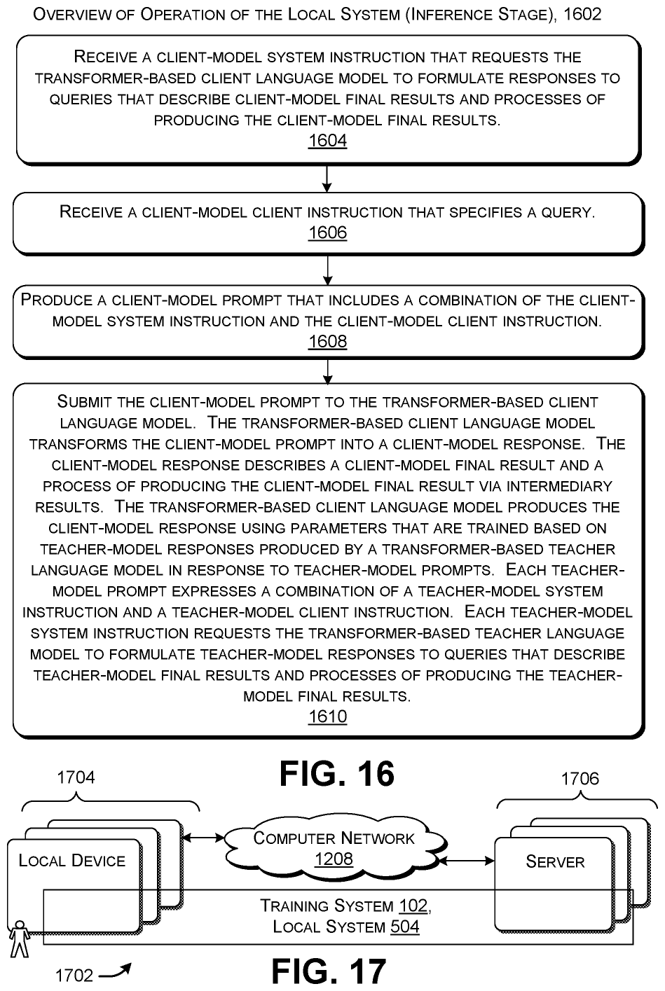

FIG. 16 shows a process 1602 of using a client language model (e.g., the client language model 506), such as the kind of transformer-based language model described with reference to FIG. 13. In block 1604, the local system 502 receives a client-model system instruction (e.g., the system instruction 518) that requests the transformer-based client language model to formulate responses to queries that describe client-model final results and processes of producing the client-model final results. In block 1606, the local system 502 receives a client-model client instruction (e.g., the client instruction 516) that specifies a query. In block 1608, the local system 502 produces a client-model prompt that includes a combination of the client-model system instruction and the client-model client instruction. In block 1610, the local system 502 submits the client-model prompt to the client language model. The transformer-based client language model transforms the client-model prompt into a client-model response (e.g., the client-model response 520). The client-model response describes a client-model final result and a process of producing the client-model final result via intermediary results. The transformer-based client language model produces the client-model response using parameters that are trained based on teacher-model responses produced by a transformer-based teacher language model (e.g., the teacher language model 104 or the teacher language model 106) in response to teacher-model prompts. Each teacher-model prompt expresses a combination of a teacher-model system instruction and a teacher-model client instruction. Each teacher-model system instruction requests the transformer-based teacher language model to formulate teacher-model responses to queries that describe teacher-model final results and processes of producing the teacher-model final results.

### F. Illustrative Computing Functionality

FIG. 17 shows computing equipment 1702 that, in some implementations, is used to implement the training system 102 of FIGS. 1 and 4, and the local system 502 of FIG. 5. The computing equipment 1702 includes a set of local devices 1704 coupled to a set of servers 1706 via a computer network 1708. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1708 is implemented as a local area network, a wide area network (e.g., the Internet), one or more point-to-point links, or any combination thereof.

The bottom-most overlapping box in FIG. 17 indicates that the functionality of the training system 102 and/or the local system 502 is capable of being spread across the local devices 1704 and/or the servers 1706 in any manner. In one example, the training system 102 is entirely implemented by a local device or the servers 1706. In one example, the local system 502 is entirely implemented by a local device. In other cases, some of the functions of the training system 102 and/or local system 502 are implemented by a local device, and other functions of the training system 102 and/or local system 502 are implemented by the servers 1706.

FIG. 18 shows a computing system 1802 that, in some implementations, is used to implement any aspect of the mechanisms set forth in the above-described figures. For instance, in some implementations, the type of computing system 1802 shown in FIG. 18 is used to implement any local computing device or any server shown in FIG. 17. In all cases, the computing system 1802 represents a physical and tangible processing mechanism.

The computing system 1802 includes a processing system 1804 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1802 also includes computer-readable storage media 1806, corresponding to one or more computer-readable media hardware units. The computer-readable storage media 1806 retains any kind of information 1808, such as machine-readable instructions, settings, model parameters, and/or other data. In some implementations, the computer-readable storage media 1806 includes one or more solid-state devices, one or more magnetic hard disks, one or more optical disks, magnetic tape, etc. Any instance of the computer-readable storage media 1806 uses any technology for storing and retrieving information. Further, any instance of the computer-readable storage media 1806 represents a fixed or removable unit of the computing system 1802. Further, any instance of the computer-readable storage media 1806 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media; a computer-readable storage medium or storage device is “non-transitory” in this regard.

The computing system 1802 utilizes any instance of the computer-readable storage media 1806 in different ways. For example, in some implementations, any instance of the computer-readable storage media 1806 represents a hardware memory unit (such as random access memory (RAM)) for storing information during execution of a program by the computing system 1802, and/or a hardware storage unit (such as a hard disk) for retaining/archiving information on a more permanent basis. In the latter case, the computing system 1802 also includes one or more drive mechanisms 1810 (such as a hard drive mechanism) for storing and retrieving information from an instance of the computer-readable storage media 1806.

In some implementations, the computing system 1802 performs any of the functions described above when the processing system 1804 executes computer-readable instructions stored in any instance of the computer-readable storage media 1806. For instance, in some implementations, the computing system 1802 carries out computer-readable instructions to perform each block of the processes described with reference to FIGS. 14-16. FIG. 18 generally indicates that hardware logic circuitry 1812 includes any combination of the processing system 1804 and the computer-readable storage media 1806.

In addition, or alternatively, the processing system 1804 includes one or more other configurable logic units that perform operations using a collection of logic gates. For instance, in some implementations, the processing system 1804 includes a fixed configuration of hardware logic gates, e.g., that are created and set at the time of manufacture, and thereafter unalterable. In addition, or alternatively, the processing system 1804 includes a collection of programmable hardware logic gates that are set to perform different application-specific tasks. The latter category of devices includes programmable array logic devices (PALs), generic array logic devices (GALs), complex programmable logic devices (CPLDs), field-programmable gate arrays (FPGAs), etc. In these implementations, the processing system 1804 effectively incorporates a storage device that stores computer-readable instructions, insofar as the configurable logic units are configured to execute the instructions and therefore embody or store these instructions.

In some cases (e.g., in the case in which the computing system 1802 represents a user computing device), the computing system 1802 also includes an input/output interface 1814 for receiving various inputs (via input devices 1816), and for providing various outputs (via output devices 1818). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1820 and an associated graphical user interface presentation (GUI) 1822. The display device 1820 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1802 also includes one or more network interfaces 1824 for exchanging data with other devices via one or more communication conduits 1826. One or more communication buses 1828 communicatively couple the above-described units together.

The communication conduit(s) 1826 is implemented in any manner, e.g., by a local area computer network, a wide area computer network (e.g., the Internet), point-to-point connections, or any combination thereof. The communication conduit(s) 1826 include any combination of hardwired links, wireless links, routers, gateway functionality, name servers, etc., governed by any protocol or combination of protocols.

FIG. 18 shows the computing system 1802 as being composed of a discrete collection of separate units. In some cases, the collection of units corresponds to discrete hardware units provided in a computing device chassis having any form factor. FIG. 18 shows illustrative form factors in its bottom portion. In other cases, the computing system 1802 includes a hardware logic unit that integrates the functions of two or more of the units shown in FIG. 18. For instance, in some implementations, the computing system 1802 includes a system on a chip (SoC or SOC), corresponding to an integrated circuit that combines the functions of two or more of the units shown in FIG. 18.

The following summary provides a set of illustrative examples of the technology set forth herein.

(A1) According to one aspect, a method (e.g., the process 1402) is described for training a machine-trained model. The method includes, in a training example-generating operation, generating a plurality of training examples, each training example being produced by: receiving (e.g., in block 1404) a system instruction (e.g., the system instruction 114) that requests a teacher language model (e.g., the teacher language model 104 or 106) to formulate responses to queries that describe final results and processes for producing the final results; receiving (e.g., in block 1406) a client instruction (e.g., the client instruction 116) that specifies a query; producing (e.g., in block 1408) a combined prompt (e.g., the prompt 112) that includes a combination of the system instruction and the client instruction; submitting (e.g., in block 1410) the combined prompt to the teacher language model. The teacher language model transforms the combined prompt into a teacher-model response (e.g., the teacher-model response 136). The teacher-model response describes a final result and a process for producing the final result. The method further includes storing (e.g., in block 1412) a training example in a data store (e.g., the data store 134) that includes the combined prompt and the teacher-model response, the data store storing the plurality of training examples. In a training operation, the method includes training (e.g., in block 1416) parameters of a student language model (e.g., the student language model 406) based on the training examples.

(A2) According to some implementations of the method of A1, the system instruction instructs the teacher language model to provide a description by directly or indirectly requesting the teacher language model to specify at least one intermediary result that leads to the final result, and the teacher language model satisfies the system instruction by providing the at least one intermediary result and the final result.

(A3) According to some implementations of the methods of A1 or A2, the teacher language model is a different model than the student language model, the teacher language model having greater capabilities compared to the student language model, and/or the teacher language model consuming more resources compared to the student language model, and/or the teacher language model having a larger size than the student language model.

(A4) According to some implementations of any of the methods of A1 or A2, the teacher language model is a same model as the student language model, acting in a context of a teacher.

(A5) According to some implementations of any of the methods of A1-A4, the combined prompt that is provided to the teacher language model also specifies the final result, which serves as a ground-truth answer, the system instruction asking the teacher language model to describe how the final result is produced.

(A6) According to some implementations of any of the methods of A1-A5, the method further includes using the teacher language model to improve the teacher-model response in one or more improvement operations.

(A7) According to some implementations of any of the methods of A1-A6, the teacher language model is invoked in response to a determination that a student-model response fails a prescribed quality test.

(A8) According to some implementations of any of the methods of A1-A7, the client instruction is a multi-modal client instruction that provides a text-based question and an item that includes content besides text, the text-based question being directed to the item.

(A9) According to some implementations of any of the methods of A1-A8, the training example-generating operation further includes extracting a set of queries from a larger collection of queries, the query being one query in the set of queries. The larger collection of queries includes plural sub-collections of queries pertaining to different respective categories. The extracting includes, for each category-of-interest, selecting a prescribed category-specific amount of queries from a sub-collection pertaining to the category-of-interest.

(A10) According to some implementations of any of the methods of A1-A9, the training operation further includes submitting a student-model prompt to the student language model, and, in response, receiving a student-model response. The student-model response describes a student-model final result and a process for producing the student-model final result. The method further includes: generating a measure of loss that depends on a difference between the teacher-model response and the student-model response; and updating parameters of the student language model based on the loss.

(A11) According to some implementations of any of the methods of A1-A10, the set of training examples includes a first set of training examples and a second set of training examples. The training operation performs training using the first set of training examples, and then performs training using the second set of training examples.

(A12) According to some implementations of the method of A11, the teacher language model is one of a first teacher language model or a second teacher language model in a teacher system that includes the first and second teacher language models, the second teacher language model being more capable than the first teacher language model. The first teacher language model is used to produce the first set of training examples. The second teacher language model is used to produce the second set of training examples.

(A13) According to some implementations of the method of A12, the second teacher language model has a throughput that is higher than a throughput of the first teacher language model. The interaction with the second teacher language model incurs a latency that is higher than a latency of the first teacher language model.

(A14) According to some implementations of the method of A11, the first set of training examples are generated for a first set of queries having a first complexity level. The second set of training examples are generated for a second set of queries having a second complexity level.

(A15) According to some implementations of any of the methods of A11-14, there are more training examples in the first set of training examples compared to the second set of training examples.

(A16) According to some implementations of any of the methods of A1-A15, the method further includes providing the student language model to a local system, the local system using the student language model to provide responses to newly-submitted queries.

(A17) According to some implementations of the method of A16, the student language model is capable of generating responses to the newly-submitted queries in an offline mode, independent of any network-accessible resources.

(B1) According to another aspect, a method (e.g., the process 1502) is described for performing a training operation. The training operation includes submitting (e.g., in block 1504) a student-model prompt to a student language model, and, in response, receiving a student-model response. The student-model prompt expresses a combination of a student-model system instruction and a student-model client instruction. The student-model system instruction requests the student language model to formulate responses to queries that describe student-model final results and processes of producing the student-model final results. The student-model client instruction expressing a query. The student-model response describes a student-model final result and a process of producing the student-model final result. The method also includes receiving (e.g., in block 1506) a teacher-model response, the teacher-model response being produced by a teacher language model based on a teacher-model prompt. The teacher-model prompt includes a teacher-model system instruction that requests the teacher language model to formulate responses to queries that describe teacher-model final results and processes of producing the teacher-model final results. The teacher-model response describes a teacher-model final result and a process of producing the teacher-model final result. The method further includes: generating (e.g., in block 1508) a measure of loss that depends on a difference between the teacher-model response and the student-model response; updating (e.g., in block 1510) parameters of the student language model based on the loss; and repeating (e.g., in loop 1512) the submitting, receiving, generating, and updating for other prompts.

(C1) According to another aspect, a method (e.g., the process 1602) is described for using a transformer-based client language model (e.g., the client language model 506). The method includes: receiving (e.g., in block 1604) a client-model system instruction that requests the transformer-based client language model to formulate responses to queries that describe client-model final results and processes of producing the client-model final results; receiving (e.g., in block 1606) a client-model client instruction that specifies a query; and producing (e.g., in block 1608) a client-model prompt that includes a combination of the client-model system instruction and the client-model client instruction. The method also includes submitting (e.g., in block 1610) the client-model prompt to the transformer-based client language model. The transformer-based client language model transforms the client-model prompt into a client-model response. The client-model response describes a client-model final result and a process of producing the client-model final result via intermediary results. The transformer-based client language model produces the client-model response using parameters that are trained based on teacher-model responses produced by a transformer-based teacher language model in response to teacher-model prompts. Each teacher-model prompt expresses a combination of a teacher-model system instruction and a teacher-model client instruction. Each teacher-model system instruction requests the transformer-based teacher language model to formulate teacher-model responses to queries that describe teacher-model final results and processes of producing the teacher-model final results.

In yet another aspect, some implementations of the technology described herein include a computing system (e.g., the computing system 1802) that includes a processing system (e.g., the processing system 1804) having a processor. The computing system also includes a storage device (e.g., the computer-readable storage media 1806) for storing computer-readable instructions (e.g., information 1808). The processing system executes the computer-readable instructions to perform any of the methods described herein (e.g., any individual method of the methods of A1-A17, B1, or C1).

In yet another aspect, some implementations of the technology described herein include a computer-readable storage medium (e.g., the computer-readable storage media 1806) for storing computer-readable instructions (e.g., the information 1808). A processing system (e.g., the processing system 1804) executes the computer-readable instructions to perform any of the operations described herein (e.g., the operations in any individual method of the methods of A1-A17, B1, or C1).

More generally, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1812 of FIG. 18. The term “logic” likewise encompasses various physical and tangible mechanisms for performing a task. For instance, each processing-related operation illustrated in the flowcharts of FIGS. 14-16 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. Finally, the terms “exemplary” or “illustrative” refer to one implementation among g potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for training a machine-trained model, comprising:
in a training example-generating operation, generating a plurality of training examples, each training example being produced by:
receiving a system instruction that requests a teacher language model to formulate responses to queries that describe final results and processes of producing the final results;
receiving a client instruction that specifies a query;
producing a combined prompt that combines the system instruction and the client instruction;
submitting the combined prompt to the teacher language model, the teacher language model transforming the combined prompt into a teacher-model response, the teacher-model response describing a final result and a process of producing the final result;
storing a training example in a data store that includes the combined prompt and the teacher-model response, the data store storing the plurality of training examples; and
in a training operation, training parameters of a student language model based on the training examples.

2. The method of claim 1, wherein the system instruction instructs the teacher language model to provide a description by directly or indirectly requesting the teacher language model to specify at least one intermediary result that leads to the final result, and the teacher language model satisfies the system instruction by providing said at least one intermediary result and the final result.

3. The method of claim 1, wherein the teacher language model is a different model than the student language model, the teacher language model having greater capabilities compared to the student language model, and/or the teacher language model consuming more resources compared to the student language model, and/or the teacher language model having a larger size than the student language model.

4. The method of claim 1, wherein the teacher language model is a same model as the student language model, acting in a context of a teacher.

5. The method of claim 1, wherein the combined prompt that is provided to the teacher language model also specifies the final result, which serves as a ground-truth answer, and wherein the system instruction asks the teacher language model to describe how the final result is produced.

6. The method of claim 1, further comprising using the teacher language model to improve the teacher-model response in one or more improvement operations.

7. The method of claim 1, wherein the teacher language model is invoked in response to a determination that a student-model response fails a prescribed quality test.

8. The method of claim 1, wherein the client instruction is a multi-modal client instruction that provides a text-based question and an item that includes content other than text, the text-based question being directed to the item.

9. The method of claim 1,
wherein the training example-generating operation further comprises extracting a set of queries from a larger collection of queries, the query being one query in the set of queries,
wherein the larger collection of queries include plural sub-collections of queries pertaining to different respective categories, and
wherein the extracting comprises, for each category-of-interest, selecting a prescribed category-specific amount of queries from a sub-collection pertaining to the category-of-interest.

10. The method of claim 1, wherein the training operation further comprises:
submitting a student-model prompt to the student language model, and, in response, receiving a student-model response, the student-model response describing a student-model final result and a process for producing the student-model final result;
generating a measure of loss that depends on a difference between the teacher-model response and the student-model response; and
updating parameters of the student language model based on the loss.

11. The method of claim 1,
wherein the set of training examples includes a first set of training examples and a second set of training examples, and
wherein the training operation performs training using the first set of training examples, and then performs training using the second set of training examples.

12. The method of claim 11,
wherein the teacher language model is one of a first teacher language model or a second teacher language model in a teacher system that includes the first and second teacher language models, the second teacher language model being more capable than the first teacher language model,
wherein the first teacher language model is used to produce the first set of training examples, and
wherein the second teacher language model is used to produce the second set of training examples.

13. The method of claim 12, wherein the second teacher language model has a throughput that is higher than a throughput of the first teacher language model, and wherein interaction with the second teacher language model incurs a latency that is higher than a latency of the first teacher language model.

14. The method of claim 11,
wherein the first set of training examples are generated for a first set of queries having a first complexity level, and
wherein the second set of training examples are generated for a second set of queries having a second complexity level.

15. The method of claim 11, wherein there are more training examples in the first set of training examples compared to the second set of training examples.

16. The method of claim 1, further comprising providing the student language model to a local system, the local system using the student language model to provide responses to newly-submitted queries.

17. The method of claim 16, wherein the student language model is capable of generating responses to the newly-submitted queries in an offline mode, independent of any network-accessible resources.

18. A computer-readable storage medium for storing computer-readable instructions, a processing system executing the computer-readable instructions to perform a training operation, the training operation comprising:
submitting a student-model prompt to a student language model, and, in response, receiving a student-model response,
the student-model prompt expressing a combination of a student-model system instruction and a student-model client instruction,
the student-model system instruction requesting the student language model to formulate responses to queries that describe student-model final results and processes of producing the student-model final results,
the student-model client instruction expressing a query,
the student-model response describing a student-model final result and a process of producing the student-model final result;
receiving a teacher-model response, the teacher-model response being produced by a teacher language model based on a teacher-model prompt, the teacher-model prompt including a teacher-model system instruction that requests the teacher language model to formulate responses to queries that describe teacher-model final results and processes of producing the teacher-model final results,
the teacher-model response describing a teacher-model final result and a process of producing the teacher-model final result;
generating a measure of loss that depends on a difference between the teacher-model response and the student-model response;
updating parameters of the student language model based on the loss; and
repeating the submitting, receiving, generating, and updating for other prompts.

19. A system for using a transformer-based client language model, comprising:
a data store for storing computer-readable instructions;
a processing system for executing the computer-readable instructions in the data store, to perform operations including:
receiving a client-model system instruction that requests the transformer-based client language model to formulate responses to queries that describe client-model final results and processes of producing the client-model final results;
receiving a client-model client instruction that specifies a query;
producing a client-model prompt that includes a combination of the client-model system instruction and the client-model client instruction; and
submitting the client-model prompt to the transformer-based client language model, the transformer-based client language model transforming the client-model prompt into a client-model response, the client-model response describing a client-model final result and a process of producing the client-model final result via intermediary results,
the transformer-based client language model producing the client-model response using parameters that are trained based on teacher-model responses produced by a transformer-based teacher language model in response to teacher-model prompts, each teacher-model prompt expressing a combination of a teacher-model system instruction and a teacher-model client instruction, and
each teacher-model system instruction requesting the transformer-based teacher language model to formulate teacher-model responses to queries that describe teacher-model final results and processes of producing the teacher-model final results.

20. The system of claim 19,
wherein the system is a local system that locally implements the transformer-based client language model, and
wherein the transformer-based client language model is capable of operating in an offline mode, independent of interaction with network-accessible resources.
